(19) United States
(12) Patent Application Publication
(10) Pub. No.: US 2006/0266611 A1
(43) Pub. Date: Nov. 30, 2006

(54) Spring assembly for an overrunning clutch

(75) Inventors: John R. Updyke, Horseheads, NY (US); Kelly P. Heath, Corning, NY (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Hilliard Corporation

(21) Appl. No.: 11/136,118

(22) Filed: May 24, 2005

(51) Int. Cl. F16D 41/06

(52) U.S. Cl. 192/44

(57) ABSTRACT

A spring assembly for biasing rolls in a roll cage of a bi-directional overrunning clutch. The spring assembly adapted to bias two adjacent rolls in opposite directions. The spring a sheet of resilient material with a plurality of slots formed in the sheet. Each slot is spaced apart from an adjacent slot and has two ends and two sides. A mounting flange is formed on at least one side of each slot and extends into the slot. A spring is located on the mounting flange and positioned within the slot, the spring has two arms which extend in opposite directions from the mounting flange. Each arm of the spring is adapted to contact a roll.

### FIELD OF THE INVENTION

The present invention relates to clutches and, more particularly, to a spring assembly for use in an overrunning clutch.

### BACKGROUND OF THE INVENTION

U.S. Pat. No. U.S. Pat. No. 5,971,123 describes an innovative bi-directional overrunning clutch for use in a vehicle. Such clutches have been extremely useful in on-road, off-road and all terrain vehicles due to their ability to change in response to road conditions.

Generally, all four-wheel drive vehicles include a differential for transferring torque from a drive shaft to the driven shafts that are attached to the wheels. Typically, the driven shafts (or half shafts) are independent of one another allowing differential action to occur when one wheel attempts to rotate at a different speed than the other, for example when the vehicle turns. The differential action also eliminates tire scrubbing, reduces transmission loads and reduces understeering during cornering (the tendency to go straight in a corner). There are various types of differentials currently in use, such as open, limited slip, locking, and center differentials.

Many differentials on the market use some form of an overrunning clutch to transmit torque when needed to a driven shaft. One successful overrunning clutch is sold by The Hilliard Corporation and is described in U.S. Pat. No. U.S. Pat. No. 5,971,123, which is incorporated herein by reference in its entirety. In that design, an electromechanical bi-directional overrunning clutch differential utilizes electrically controlled coils to advance and retard a roll cage, thereby controlling the ability of the differential to engage and disengage depending on the operational state of the primary and secondary wheels. The bi-directional differential in U.S. Pat. No. 5,971,123 also describes a backdriving system. The backdriving system operates by controlling the energizing of selected coils to actively engage the secondary shafts in certain situations where extra traction is needed. For example, when the vehicle is driving down a slope the system engages the front wheels, which are the wheels with the better traction.

In order to account for tolerances between the output hubs and the clutch housing, the clutch describes in U.S. Pat. No. 5,971,123 incorporates a unique spring design to assist in the centering of the rolls in the roll cage. Poor control of tolerances between an output hub and a clutch housing could result in less than all the rolls engaging at the same time, reducing the amount of torque that can be transferred. The spring designs is described in detail in U.S. Pat. No. 6,629,590, which is incorporated herein by reference in its entirety.

While the springs shown in U.S. Pat. No. 6,629,590 provide a tremendous benefit and solve many of the deficiencies associated with prior differential clutches, each spring is independently mounted to the roll cage. It would be beneficial to include in the clutch a spring design which could be easily assembled and installed.

### SUMMARY OF THE INVENTION

The present invention relates to a spring assembly for biasing rolls in an overrunning clutch. The clutch includes a roll cage disposed between a clutch housing and at least one race. The roll cage includes a plurality of rolls located within slots formed in the roll cage. The clutch is designed to transmit torque when the rolls are wedged between the race and the clutch housing.

In one embodiment, the spring assembly includes a sheet of resilient material, such as spring steel, with a plurality of slotted openings cut in it. The slotted openings are preferably arranged in two rows and are spaced apart from one another. Each slotted opening includes two sides and two ends. At least one and more preferably two springs are mounted in each slotted opening. Each spring is attached to approximately the middle of a side of the slotted opening through a base mount. Each spring includes two arms that extend laterally from the base mount toward opposite ends of the slot. Each arm is configured to contact a roll in the overrunning clutch.

The foregoing and other features and advantages of the present invention will become more apparent in light of the following detailed description of the preferred embodiments thereof, as illustrated in the accompanying figures.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 is a top plan view of a spring assembly according to one embodiment of the present invention prior to installation in an overrunning clutch.

FIG. 2 is a side view of the spring assembly of FIG. 1.

FIG. 3 is partial cross-sectional view of the spring assembly taken along lines 3-3 in FIG. 1.

FIG. 4 is partial cross-sectional view of the spring assembly taken along lines 4-4 in FIG. 1.

FIG. 5 is an enlarged view of a portion of the spring assembly of FIG. 1 as indicated.

FIG. 6 is a partial top view of the spring assembly taken along lines 6-6 in FIG. 1.

FIG. 7 is a cross-sectional view of a roll cage with the spring assembly of FIG. 1 installed.

FIG. 8 is an enlarged view of a portion of the roll cage assembly of FIG. 7 as indicated.

FIG. 9 is a top plan view of a sheet after die cutting for forming the spring assembly of FIG. 1.

FIG. 10 is an enlarged view of a portion of the sheet of FIG. 9 as indicated.

### DETAILED DESCRIPTION OF THE EMBODIMENTS

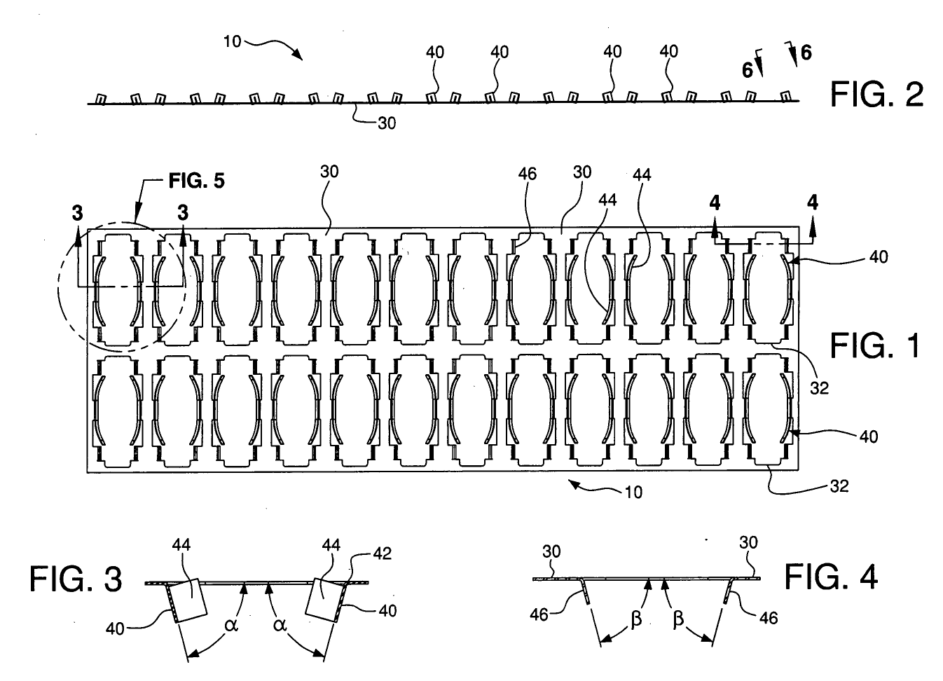

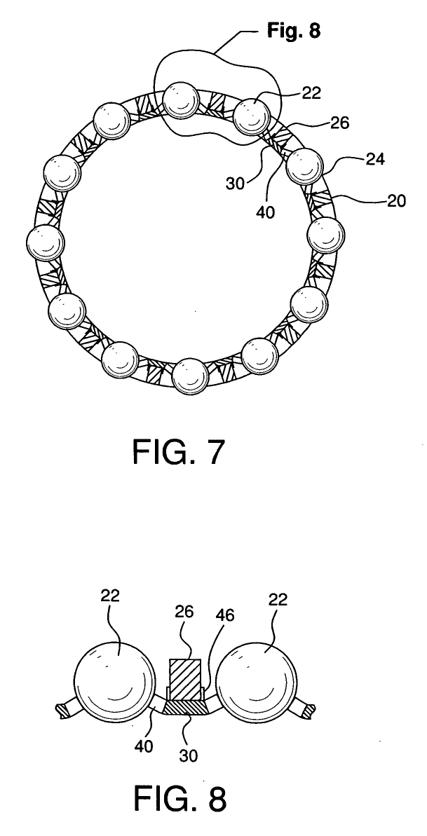

Referring now to the drawings, wherein like reference numerals illustrate corresponding or similar elements throughout the several views, FIG. 1 illustrates a spring assembly 10 for biasing rolls in a bi-directional overrunning clutch. The clutch includes a roll cage 20 disposed between a clutch housing and at least one race. The roll cage 20 includes a plurality of rolls 22 located within slots 24 formed in the roll cage 20. The rolls 22 are movable with respect to the roll cage 20 so as to engage (wedge) and disengage between the clutch housing and the race. The roll cage 20 is shown in FIG. 7 along with the spring assembly 10 in its installed state. The details of the operation and configuration of the roll cage 20 are discussed in U.S. Pat. No. 6,629,590, which is incorporated herein by reference in its entirety. As such, further discussion on the operation of the overrunning clutch and roll cage are not necessary in the present application and reference is made to U.S. Pat. No. 6,629,590 for further background.

As discussed in U.S. Pat. No. 6,629,590, springs are mounted to the roll cage to accommodate spacing variations between the clutch housing and the race such that the rolls all engage at substantially the same time. As a result, the roll cage does not need to be piloted onto the clutch housing, but may be free to float.

The floating of the roll cage provides a unique advantage over prior roll cage designs. In prior designs, the tolerances between both output hubs and the clutch housing had to be closely controlled. In those prior designs if the spacing between one output hub and the clutch housing differed from the spacing between the other output hub and the clutch housing, the rolls would not engage both output hubs. As such, torque would only transmit through one output hub. Also, the location of the slots which retained the rolls also had to be closely controlled since imprecise location of a slot could result in less than all the rolls engaging with an output hub.

The spring assembly of the present invention overcomes these deficiencies by allowing the rolls to float and become self-adjusting. As such, the rolls engage simultaneously with the clutch housing and both output hubs, thereby maximizing torque transmission through the differential and providing control over both wheels.

Referring to FIGS. 1 and 3, in the illustrated embodiment, a novel spring assembly 10 is shown. The spring assembly 10 is formed as a substantially flat sheet 30 of resilient material, such as spring steel. The sheet 30 includes a plurality of slotted openings 32 that are formed in the sheet, such as by punching or cutting. The slotted openings 32 are arranged in two rows, with the slots 32 preferably being substantially equally spaced and aligned as shown. Each slotted opening 32 includes two sides 34 and two ends 36, preferably forming a generally rectangular opening.

Two springs 40 are mounted in each slotted opening. In the illustrated embodiment, each spring 40 is attached to approximately the middle of one of the sides 34 by a base mount 42. In the preferred embodiment, the springs 40 and the base mounts 42 are formed integral with the sheet 30.

Each spring 40 includes two arms 44 that extend laterally from the base mount 42 toward opposite ends of the slot. The arms 44 are preferably integral as shown, however the attachment to the base mount 42 permits each arm to deflect substantially independent from the other arm.

The base mounts 42 preferably extend outward from the sides 34 and lie in substantially the same plane as the sheet 30 surrounding the slot 32. The term “plane” as used herein refers to the plane of the sheet 30 when the sheet is in the initial state shown in FIG. 1. It should be understood that the intended final shape of the sheet 30 is a substantially cylindrical shape as shown in FIG. 7. The springs 40 are bent out of the plane of the sheet 30 such that the springs 40 protrude outward from the slotted opening 32 as shown in FIGS. 2 and 3. As discussed in U.S. Pat. No. 6,629,590, the springs 40 are configured to locate or position rolls within slots formed in the roll cage. Preferably the springs 40 are designed to substantially center the rolls in the slotted opening 32. However, the present invention also has applicability to a unidirectional overrunning clutch and, as such, the springs may be arranged to bias the rolls to one side of the slots in the roll cage. When formed, the springs 40 are preferably at an angle α of between about 60 degrees to about 85 degrees. In one embodiment, the springs 40 form an angle α of about 75 degrees. Of course, those skilled in the art would readily appreciate that the angle a of the springs 40 relative to the sheet 30 can vary depending on various factors including the size of the slotted opening 32, length of the springs, thickness of the roll cage and the size of the rolls.

The illustrated embodiment shows the arms 44 of each spring 40 as flat or leaf springs that are bent into the slotted openings 32. In one exemplary embodiment, each arm 44 has a radial bend R of about 0.50 inches so that the arm 44 projects into the slotted opening 32.

As shown in FIG. 7, the flat sheet 30 is bent or otherwise rolled into a substantially cylindrical shape for mounting to the roll cage 20. Preferably the sheet 30 is placed against an inside surface of the roll cage 20 such that the springs 40 project into the slots formed in the roll cage 20 as shown in FIG. 7. Of course, it is also possible to mount the spring assembly 10 to the outside of the roll cage 20. However, one of the advantages of an internally mounted assembly is that the spring want to maintain a flat state and, as such, has less need of mechanical fasteners or locators to maintain its position.

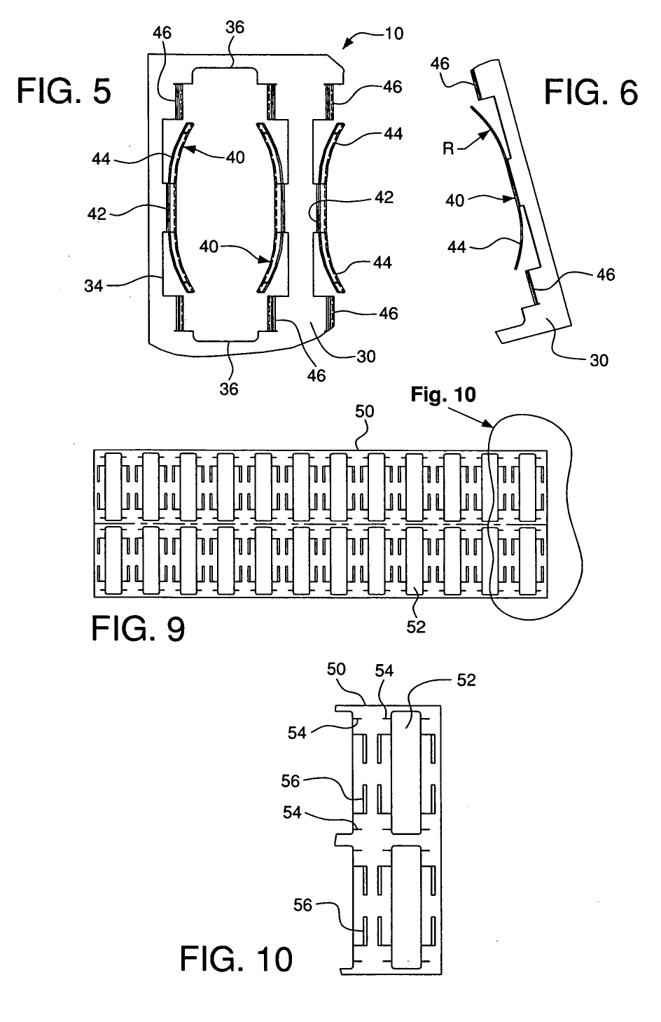

The attachment of the spring assembly 10 to the roll cage can be through an number of means. However, the spring assembly 10 is preferably mounted to the roll cage 20 such that the springs 40 are properly positioned within each slot 24. One method for doing so is by clipping or engaging the spring assembly 10 with one or more of the cage frames or walls 26 that separate adjacent slots 24. More particularly, referring to FIGS. 1, 4-6 and 8, tabs 46 may be formed on the sheet 30 adjacent to the slotted opening, each tab 46 preferably extending from a side 34. The tabs 46 project out of the plane of the sheet 30 in the same direction as springs 40. Preferably the tabs 46 project at an angle β of between about 65 degrees and about 90 degrees with respect to the sheet. In one embodiment, the angle β is approximately 75 degrees. Tabs 46 in adjacent slotted openings 32 are preferably spaced apart from one another by an amount substantially equal to the width of the cage frames 26 such that the tabs 46 engage with the sides of the cage frame 26, thereby engaging the spring assembly 10 to the roll cage 20.

In one exemplary embodiment, the cage frame 26 has a width of approximately 0.312 inches and the tabs 46 are bend up to form a spacing of between about 0.312 inches and 0.350 inches. As shown in the figures, the tabs 46 can be formed near both ends 36 of the slotted openings 32. The resiliency of the sheet 30 urges the sheet against the inside surface of the roll cage, thereby assisting in engaging the sheet to the cage.

In one embodiment of the invention, the sheet 30 is made from hardened stainless steel material with a thickness of about 0.008 inches. Other materials and thickness can be used with the present invention. In the illustrated embodiment there are 24 slotted openings 32 formed in the sheet, arranged in two rows of 12 slotted openings. Other arrangements are possible other than that shown in the figures.

The spring assembly 10, is preferably formed from a single sheet of material with the slotted openings 32, springs 40 and tabs 46, being formed by a punch. As shown in FIGS. 9 and 10, the springs 40 and tabs 46 can be formed from the sheet 30 material and then subsequently bent into the final form. A blank sheet 50 is placed between a punch and die. The punch and die cuts into the sheet 50, cutting out a slot of material 52, forming cuts 54 that define the tabs, and forming cuts 56 to define the arms of the springs 40. The tabs 46 and springs 40 are bent out of the plane of the sheet as discussed above. Other methods can be used to form the spring assembly 10, such as by laser or other cutting arrangements.

The above-described spring assembly provides a unique spring design that facilitates assembly of an overrunning clutch.

Although the invention has been described and illustrated with respect to the exemplary embodiments thereof, it should be understood by those skilled in the art that the foregoing and various other changes, omissions and additions may be made therein and thereto, without parting from the spirit and scope of the present invention.

We claim:

1. A spring assembly for biasing rolls in an overrunning clutch, the clutch including a roll cage disposed between a clutch housing and at least one race, and a plurality of rolls located within slots formed in the roll cage, the rolls movable with respect to the roll cage, the spring assembly adapted to bias two adjacent rolls in opposite directions, the spring assembly comprising:
a sheet of resilient material;
a plurality of cut-outs formed in the sheet and spaced apart from one another, each cutout having two ends and two sides;
a mounting flange formed on at least one side of each cutout and extending into the cutout; and
a spring formed on the mounting flange and positioned within the cutout, the spring having at least one arm which extends from the mounting flange, the arm adapted to contact a roll.

2. A spring assembly according to claim 1 wherein each spring has two arms, the arms extending in opposite directions from the mounting flange, each arm adapted to contact a roll at a different location on the roll, the springs and mounting flange being formed integral with the sheet.

3. A spring assembly according to claim 2 wherein there are two mounting flanges formed in each slot, each mounting flange being on an opposite side of the slot and projecting into the slot, and wherein each spring arm is bent at an angle to the sides such that the spring arms project out of a plane extending across from one side to the other of each slot.

4. A spring assembly according to claim 3 wherein each spring arm is bent at an angle to the plane in a range between about 60 degrees and 85 about degrees.

5. A spring assembly according to claim 3 wherein each spring arm is bent at an angle to the plane of about 75 degrees.

6. A spring assembly according to claim 3 wherein at least a portion of each spring arm has a curvature of about 0.50 inches.

7. A spring assembly according to claim 1 wherein the slots are arranged in two rows in the sheet, and wherein the slots in a row are spaced substantially equally from one another.

8. A spring assembly according to claim 7 wherein the sheet in bent into a substantially cylindrical shape and located inside the roll cage such that the slots in the spring assembly are positioned substantially below the slotted openings in the roll cage.

9. A spring assembly for biasing rolls in an overrunning clutch, the clutch including a roll cage disposed between a clutch housing and at least one race, and a plurality of rolls located within slotted openings formed in the roll cage, the rolls movable with respect to the roll cage, the spring assembly adapted to bias two adjacent rolls in opposite directions, the spring assembly comprising:
a sheet of resilient material;
a plurality of slots formed in the sheet and spaced apart from one another, each slot having two ends and two sides;
a mounting flange formed on each side of each slot and extending into the slot; and
a spring formed on each mounting flange and positioned within the slot, the spring having two arms, the arms extending in opposite directions from the mounting flange, each arm adapted to contact a roll and deflect independently from the other arm.

10. A spring assembly according to claim 9 wherein each spring arm is bent at an angle to the sides such that the spring arms project out of a plane extending across from one side to the other of each slot.

11. A spring assembly according to claim 10 wherein each spring arm is bent at an angle to the plane in a range between about 60 degrees and 85 about degrees.

12. A spring assembly according to claim 11 wherein each spring arm is bent at an angle to the plane of about 75 degrees.

13. A spring assembly according to claim 9 wherein the slots are arranged in two rows in the sheet, and wherein the slots in a row are spaced substantially equally from one another.

14. A spring assembly according to claim 13 wherein the sheet in bent into a substantially cylindrical shape and located inside the roll cage such that the slots in the spring assembly are positioned substantially below the slotted openings in the roll cage.

15. A spring assembly for biasing rolls in a bi-directional overrunning clutch, the clutch including a roll cage disposed between a clutch housing and at least one race, and a plurality of rolls located within slotted openings formed in the roll cage, the rolls movable with respect to the roll cage, the spring assembly adapted to bias two adjacent rolls in opposite directions, the spring assembly comprising:
a sheet of resilient material;
a plurality of slots formed in the sheet, the slots being arranged in two rows in the sheet, the slots in a row being spaced substantially equally from one another, each slot having two ends and two sides;
a mounting flange formed on each side of each slot and extending into the slot; and
a spring formed on each mounting flange and positioned within the slot, the spring having two arms, the arms extending in opposite directions from the mounting flange, each arm adapted to contact a roll and deflect independently from the other arm, each spring arm being bent at an angle to the sides such that the spring arms project out of a plane extending across from one side to the other of each slot; and
a plurality of tabs formed on the sheet adjacent to at least some slots, the tabs extending from opposite sides of the slots and projecting out from the plane
the sheet being bent into a substantially cylindrical shape and located inside the roll cage such that the slots in the spring assembly are positioned substantially below the slotted openings in the roll cage.
